(19) United States
(12) Patent Application Publication
(10) Pub. No.: US 2018/0052946 A1
(43) Pub. Date: Feb. 22, 2018

(54) COMPONENT DEFORMATION DETECTION SYSTEM, COMPUTER PROGRAM PRODUCT AND RELATED METHODS

(71) Applicant: General Electric Company, Schenectady, NY (US)

(72) Inventors: Truman Blake Horner, Greenville, SC (US); Sze Bun Brian Chan, Marietta, GA (US); John Robert Korsedal, Greenville, SC (US); Joseph Leonard Moroso, Greenville, SC (US); Ian Darnall Reeves, Easley, SC (US); Birol Turan, Istanbul (TR); Stephen Paul Wassynger, Simpsonville, SC (US)

(21) Appl. No.: 15/240,279

(22) Filed: Aug. 18, 2016

(51) Int. Cl. G06F 17/50

(52) U.S. Cl. CPC G06F 17/50

(57) ABSTRACT

Various embodiments include a system having: a computing device configured to detect deformation in a manufactured component by: obtaining a post-deployment three-dimensional (3D) depiction of the manufactured component; obtaining a model of the manufactured component including: a nominal shape model indicating a nominal shape of the manufactured component prior to operational deployment, and an expected deformation model indicating expected deformation of the manufactured component after operational deployment; aligning a localized region of the manufactured component in the post-deployment 3D depiction with the localized region of the manufactured component in the nominal shape model; identifying a first set of points in the localized region not subject to deformation between the post-deployment 3D depiction and the nominal shape model; and identifying a second set of points in the localized region subject to deformation between the post-deployment 3D depiction and the nominal shape model.

### TECHNICAL FIELD

The subject matter disclosed herein relates to analyzing manufactured components. More particularly, the subject matter disclosed herein relates to detecting deformation in a manufactured part, e.g., a turbomachine component such as a gas turbine component, using localized data about that component.

### BACKGROUND

Conventional methods of calculating component deformation can suffer from undesirable complexity and/or inaccuracy. For example, conventional approaches of calculating component deformation, e.g., in rotating systems such as turbomachines (e.g., gas turbines), require taking measurements of reference components within the system (e.g., a centerline of a gas turbine or other datum structures) and also accounting for manufacturing process capability in order to develop significant comparisons. These approaches can be time consuming, costly, and inaccurate.

### BRIEF DESCRIPTION

Various embodiments of the disclosure include systems, methods and computer program products for detecting deformation in a manufactured component. In some cases, a system includes: at least one computing device configured to detect dimensional information (e.g., deformation information) about a manufactured component by: obtaining a post-deployment three-dimensional (3D) depiction of the manufactured component; obtaining a model of the manufactured component including: a nominal shape model indicating a nominal shape of the manufactured component prior to operational deployment, and an expected deformation model indicating expected deformation of the manufactured component after operational deployment; aligning a localized region of the manufactured component in the post-deployment 3D depiction with the localized region of the manufactured component in the nominal shape model; identifying a first set of points in the localized region not subject to deformation between the post-deployment 3D depiction and the nominal shape model; and identifying a second set of points in the localized region subject to deformation between the post-deployment 3D depiction and the nominal shape model.

A first aspect of the disclosure includes a system having: at least one computing device configured to detect dimensional information about a manufactured component by: obtaining a post-deployment three-dimensional (3D) depiction of the manufactured component; obtaining a model of the manufactured component including: a nominal shape model indicating a nominal shape of the manufactured component prior to operational deployment, and an expected deformation model indicating expected deformation of the manufactured component after operational deployment; aligning a localized region of the manufactured component in the post-deployment 3D depiction with the localized region of the manufactured component in the nominal shape model; identifying a first set of points in the localized region not subject to deformation between the post-deployment 3D depiction and the nominal shape model; and identifying a second set of points in the localized region subject to deformation between the post-deployment 3D depiction and the nominal shape model.

A second aspect of the disclosure includes a system having: a measurement system, for capturing a post-deployment three-dimensional (3D) depiction of a manufactured component; and at least one computing device coupled with the measurement system and configured to detect dimensional information (e.g., deformation information) about the manufactured component, by performing actions including: obtaining a model of the manufactured component including: a nominal shape model indicating a nominal shape of the manufactured component prior to operational deployment, and an expected deformation model indicating expected deformation of the manufactured component after operational deployment; aligning a localized region of the manufactured component in the post-deployment 3D depiction with the localized region of the manufactured component in the nominal shape model; identifying a first set of points in the localized region not subject to deformation between the post-deployment 3D depiction and the nominal shape model; and identifying a second set of points in the localized region subject to deformation between the post-deployment 3D depiction and the nominal shape model.

A third aspect of the disclosure includes a computer program product having program code, which when executed by at least one computing device, causes the at least one computing device to detect dimensional information (e.g., deformation information) about a manufactured component, by performing actions including: obtaining a post-deployment three-dimensional (3D) depiction of the manufactured component after operational deployment; obtaining a model of the manufactured component including: a nominal shape model indicating a nominal shape of the manufactured component prior to operational deployment, and an expected deformation model indicating expected deformation of the manufactured component after operational deployment; aligning a localized region of the manufactured component in the post-deployment 3D depiction with the localized region of the manufactured component in the nominal shape model; identifying a first set of points in the localized region not subject to deformation between the post-deployment 3D depiction and the nominal shape model; and identifying a second set of points in the localized region subject to deformation between the post-deployment 3D depiction and the nominal shape model.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic depiction of a system according to various embodiments of the disclosure.

FIG. 2 shows a flow diagram illustrating a method performed according to particular embodiments of the disclosure.

FIG. 3 shows a schematic depiction of a manufactured component according to various embodiments of the disclosure.

FIG. 4 shows a close-up view of a localized region of the manufactured component of FIG. 3.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the subject matter disclosed herein relates to analyzing manufactured components. More particularly, the subject matter disclosed herein relates to detecting deformation of a manufactured part, e.g., a turbomachine component such as a gas turbine component, using localized data about that component.

In contrast to conventional approaches, various embodiments of the disclosure include methods, systems and computer program products for effectively isolating areas of deformation in a component, while not requiring dimensional stack-up information relative to predefined datum structures. Approaches according to various embodiments of the disclosure can be used to detect deformation and/or predict deformation in a component, such as a rotating component (e.g., in a gas turbomachine). However, these approaches can be applied to any number of manufactured components according to various embodiments. In some cases, these approaches may be used to detect and/or predict creep in a manufactured component.

As is known in the art of material science, when a solid material is placed under mechanical stress and elevated temperature, over time, that material may have a tendency to slowly move, and even deform permanently, due to that stress. In some cases, the stress applied can be below the yield strength of the material, but due to prolonged exposure, the material may nonetheless deform. This deformation is known in the art as creep. Creep is one form of deformation that may be detected using one or more approaches described according to embodiments of the disclosure.

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings.

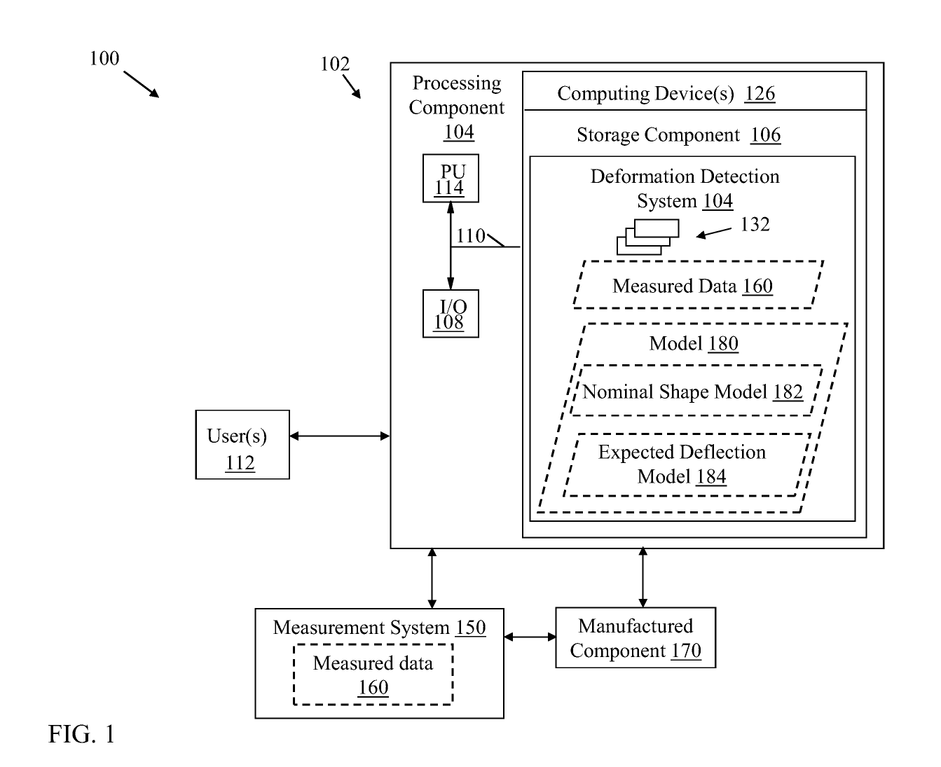

FIG. 1 shows a schematic depiction of a system 100 according to various embodiments. System 100 can include a computer system 102, including at least one computing device 126, and a measurement system 150 coupled (e.g., wirelessly and/or via hard-wired means) with computing device(s) 126 for communicating measured data (three-dimensional (3D) depictions) 160 about a manufactured component 170. In various embodiments, measurement system 150 can include a vision system and/or a tactile measurement system, such as a coordinate measurement machine (CMM), capable of collecting 3D depictions (measured data 160) about component 170. In some cases, measurement system 150 can include a camera system, e.g., a conventional blue-light camera system configured to capture a 3D depiction of manufactured component 170. In some cases, measurement system 150 can include at least one camera, but may include a plurality of cameras in various embodiments. Manufactured component 170 can include any component capable of manufacture, for example, a combustion component such as a gas turbomachine blade, nozzle, shroud, vane, etc., or other component(s) manufactured by casting, forging, and/or additive manufacturing.

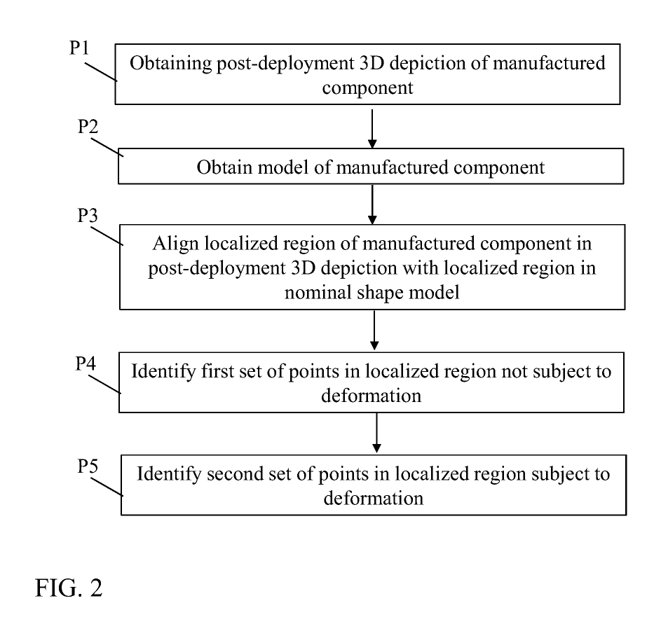

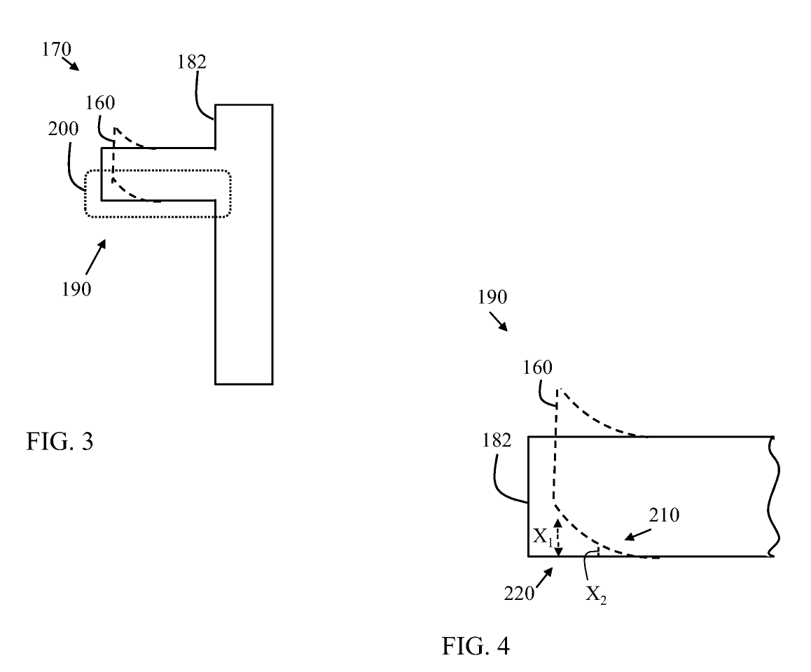

FIG. 2 shows a flow chart illustrating a method according to various embodiments of the disclosure. FIG. 3 shows a schematic depiction of manufactured component 170 illustrating various aspects of the disclosure. The flow chart is referred to simultaneously with the system diagram of FIG. 1 and the schematic depiction of manufactured component 170. In various embodiments, processes can include:

Process P1: obtaining a post-deployment three-dimensional (3D) depiction (image data 160) of manufactured component 170. In various embodiments, the post-deployment 3D depiction 160 is captured by measurement system 150, e.g., on demand or in advance. As used herein, deployment is equivalent to at least some usage of component 170 in its intended environment. For example, a combustion component is deployed when it is placed into use in a combustion environment, an automobile component is deployed when it is placed in an automobile that runs for at least some period, etc.

Process P2: obtaining a model 180 of manufactured component 170 including: a nominal shape model 182 indicating a nominal shape of manufactured component 170 prior to operational deployment, and an expected deformation model 184 indicating expected deformation of manufactured component 170 after operational deployment. Nominal shape model 182 can include 3D coordinates for manufactured component 170, and can include a data file used to form manufactured component 170, for example, a data file used to form a mold or cast into which a material (e.g., metal, composite, etc.) is poured to form manufactured component 170, and/or a data file used to instruct an additive manufacturing system in forming manufactured component 170. In various embodiments, expected deformation model 184 indicates an expected deformation of manufactured component 170, over a period, due to deployment in operation. Expected deformation model 184 can include, for example, a data file indicating deformation (e.g., creep, strain, material fatigue) of one or more locations within manufactured component 170 due to operational exposure (e.g., due to heating, cooling, moisture, etc.). Expected deformation model 184 can be customizable to particular operational conditions, with variables such as length of operation, temperature, moisture level, revolutions per period, etc. While nominal shape model 182 can indicate a nominal (e.g., ideal) manufactured version of a component, expected deformation model 184 can indicate how that nominal manufactured version of the component will deform over a period under particular conditions.

Process P3: aligning a localized region 190 (FIGS. 3, 4) of manufactured component 170 in the post-deployment 3D depiction 160 with the localized region 190 of manufactured component 170 in nominal shape model 182. In various embodiments, this can include using a conventional best fit alignment process (e.g., least sums fit, or other statistical distribution fit) to align data points representing localized region 190 in post-deployment 3D depiction 160 and nominal shape model 182. An example of this best fit approach is illustrated in FIG. 3, where best fit surfaces 200 are illustrated along with post-deployment 3D depiction 160 (representing actual shape of component 170 after deployment) and nominal shape model 182. In other embodiments, the best fit alignment process can include using a best fit of points (e.g., data points in localized region 190) and/or alignment of those points to certain feature (e.g., local features) in the nominal shape model 182. FIG. 4 shows a close-up view of localized region 190, which illustrates the distinction between post-deployment 3D depiction 160 and nominal shape model 182. In various embodiments, localized region 190 is selected based upon a common manufacturing process used to manufacture a portion of component 170. In some cases, the common manufacturing process can include at least one of casting, forging or 3D printing. Selecting localized region 190 with a common (e.g., uniform) manufacturing process across its data points allows for comparison of deformation in particular areas of localized region 190 while controlling for a significant variable (manufacturing process). In various embodiments, the common manufacturing process includes at least one of casting, forging or 3D printing.

Process P4: identifying a first set of points 210 in localized region 190 not subject to deformation between post-deployment 3D depiction 160 and nominal shape model 182. In this case, first set of points 210 can be a single data point or set of a plurality of data points that does not exhibit significant deformation in the post-deployment 3D depiction 160 as compared with nominal shape model 182. This first set of points 210 can exhibit a deformation small enough so as to distinguish itself from a greater-deformed set of points (e.g., second set of points 220) relative to its original nominal shape, due to deployment, e.g., where in some example embodiments, second set of points 220 exhibits deformation of an order of magnitude greater than first set of points 210.

Process P5: identifying a second set of points 220 in localized region 190 subject to deformation between post-deployment 3D depiction 160 and nominal shape model 182. Second set of points 220 can exhibit a deformation of greater than the deformation in first set of points 210, as noted with respect to process P4 (e.g., order of magnitude difference or other differentiating factor). According to various embodiments, the difference between the deformation at first set of points 210 and second set of points 220 can provide the localized deformation within region 190. That is, as shown in FIG. 4, where X₂ indicates a substantially non-deformed location at first set of points 210, X₁ indicates a deformed location at second set of points 220.

In some cases, according to various embodiments, the process can include obtaining a pre-deployment 3D depiction (e.g., image data 160) of manufactured component 170 prior to operational deployment. Computing device(s) 126 can further compare pre-deployment 3D depiction (e.g., image data 160) of manufactured component 170 with nominal shape model 182 to identify a manufacturing variation in the manufactured component 170, if such a variation exists. This process may be used to verify that the deformation analysis in processes P3-P5 is valid based upon operational deformation, and not due to manufacturing variation in forming manufactured component 170 prior to operational deployment.

It is understood that processes P1-P5, can be iterated on a periodic, or constant basis. Further, processes P1-P5 can be performed in any order, and particular processes may be omitted in various embodiments. Additionally, processes P1-P5 can be performed on any number of manufactured components 170,

It is understood that in the flow diagrams shown and described herein, other processes may be performed while not being shown, and the order of processes can be rearranged according to various embodiments. Additionally, intermediate processes may be performed between one or more described processes. The flow of processes shown and described herein is not to be construed as limiting of the various embodiments.

Returning to FIG. 1, system is shown including deformation detection system 104, for performing the functions described herein according to various embodiments of the invention. To this extent, the system 100 includes computer system 102 that can perform one or more processes described herein in order to detect deformation in a manufactured component 170. In particular, computer system 102 is shown as including the deformation detection system 104, which makes computer system 102 operable to detect deformation (if present) in manufactured component 170 by performing any/all of the processes described herein and implementing any/all of the embodiments described herein.

The computer system 102 is shown including computing device 126, which can include a processing component 104 (e.g., one or more processors), a storage component 106 (e.g., a storage hierarchy), an input/output (I/O) component 108 (e.g., one or more I/O interfaces and/or devices), and a communications pathway 110. In general, the processing component 104 executes program code, such as the deformation detection system 104, which is at least partially fixed in the storage component 106. While executing program code, the processing component 104 can process data, which can result in reading and/or writing transformed data from/to the storage component 106 and/or the I/O component 108 for further processing. The pathway 110 provides a communications link between each of the components in the computer system 102. The I/O component 108 can comprise one or more human I/O devices, which enable a user (e.g., a human and/or computerized user) 112 to interact with the computer system 102 and/or one or more communications devices to enable the system user 112 to communicate with the computer system 102 using any type of communications link. To this extent, the deformation detection system 104 can manage a set of interfaces (e.g., graphical user interface(s), application program interface, etc.) that enable human and/or system users 112 to interact with the deformation detection system 104. Further, the deformation detection system 104 can manage (e.g., store, retrieve, create, manipulate, organize, present, etc.) data, such as image data 60 (including post-deployment and pre-deployment depictions of manufactured component 170), nominal shape model (data) 182 and/or expected deformation model (data) 184 using any solution, e.g., via wireless and/or hardwired means.

In any event, the computer system 102 can comprise one or more general purpose computing articles of manufacture (e.g., computing devices) capable of executing program code, such as the deformation detection system 104, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the deformation detection system 104 can be embodied as any combination of system software and/or application software. It is further understood that the deformation detection system 104 can be implemented in a cloud-based computing environment, where one or more processes are performed at distinct computing devices (e.g., a plurality of computing devices 126), where one or more of those distinct computing devices may contain only some of the components shown and described with respect to the computing device 126 of FIG. 1.

Further, deformation detection system 104 can be implemented using a set of modules 132. In this case, a module 132 can enable the computer system 102 to perform a set of tasks used by the deformation detection system 104, and can be separately developed and/or implemented apart from other portions of the deformation detection system 104. As used herein, the term “component” means any configuration of hardware, with or without software, which implements the functionality described in conjunction therewith using any solution, while the term “module” means program code that enables the computer system 102 to implement the functionality described in conjunction therewith using any solution. When fixed in a storage component 106 of a computer system 102 that includes a processing component 104, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 102.

When the computer system 102 comprises multiple computing devices, each computing device may have only a portion of deformation detection system 104 fixed thereon (e.g., one or more modules 132). However, it is understood that the computer system 102 and deformation detection system 104 are only representative of various possible equivalent computer systems that may perform a process described herein. To this extent, in other embodiments, the functionality provided by the computer system 102 and deformation detection system 104 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 102 includes multiple computing devices 126, the computing devices can communicate over any type of communications link. Further, while performing a process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

While shown and described herein as a method, computer program product and system for detecting deformation in a manufactured component 170, it is understood that aspects of the invention further provide various alternative embodiments. For example, in one embodiment, the invention provides a computer program fixed in at least one computer-readable medium, which when executed, enables a computer system to detect deformation in a manufactured component 170, if present. To this extent, the computer-readable medium includes program code, such as the deformation detection system 104 (FIG. 1), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the deformation detection system 104 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of detecting deformation in a manufactured component 170 (FIG. 1). In this case, a computer system, such as the computer system 102 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

In any case, the technical effect of the various embodiments of the disclosure, including, e.g., deformation detection system 104, is to monitor a manufactured component (e.g., component 170), e.g., for potential deformation. It is understood that according to various embodiments, deformation detection system 104 could be implemented to monitor a plurality of manufactured components, such as manufactured component 170 described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system comprising:
at least one computing device configured to detect deformation in a manufactured component by performing actions including:
obtaining a post-deployment three-dimensional (3D) depiction of the manufactured component after operational deployment;
obtaining a model of the manufactured component including: a nominal shape model indicating a nominal shape of the manufactured component prior to operational deployment, and an expected deformation model indicating expected deformation of the manufactured component after operational deployment;
aligning a localized region of the manufactured component in the post-deployment 3D depiction with the localized region of the manufactured component in the nominal shape model;
identifying a first set of points in the localized region not subject to deformation between the post-deployment 3D depiction and the nominal shape model; and
identifying a second set of points in the localized region subject to deformation between the post-deployment 3D depiction and the nominal shape model.

2. The system of claim 1, wherein the at least one computing device further obtains a pre-deployment 3D depiction of the manufactured component prior to operational deployment.

3. The system of claim 2, wherein the at least one computing device further compares the pre-deployment 3D depiction of the manufactured component with the nominal shape model to identify a manufacturing variation in the manufactured component.

4. The system of claim 1, wherein the localized region is selected based upon a common manufacturing process used to manufacture a portion of the component.

5. The system of claim 4, wherein the common manufacturing process includes at least one of casting, forging or 3D printing.

6. The system of claim 1, wherein the nominal shape model includes a data file used to form the manufactured component.

7. The system of claim 1, wherein the manufactured component includes a turbomachine component.

8. A system comprising:
a measurement system for capturing a post-deployment three-dimensional (3D) depiction of a manufactured component; and
at least one computing device coupled with the measurement system and configured to detect deformation in the manufactured component, by performing actions including:
obtaining a model of the manufactured component including: a nominal shape model indicating a nominal shape of the manufactured component prior to operational deployment, and an expected deformation model indicating expected deformation of the manufactured component after operational deployment;
aligning a localized region of the manufactured component in the post-deployment 3D depiction with the localized region of the manufactured component in the nominal shape model;
identifying a first set of points in the localized region not subject to deformation between the post-deployment 3D depiction and the nominal shape model; and
identifying a second set of points in the localized region subject to deformation between the post-deployment 3D depiction and the nominal shape model.

9. The system of claim 8, wherein the at least one computing device further obtains a pre-deployment 3D depiction of the manufactured component prior to operational deployment.

10. The system of claim 9, wherein the at least one computing device further compares the pre-deployment 3D depiction of the manufactured component with the nominal shape model to identify a manufacturing variation in the manufactured component.

11. The system of claim 8, wherein the localized region is selected based upon a common manufacturing process used to manufacture a portion of the component.

12. The system of claim 11, wherein the common manufacturing process includes at least one of casting, forging or 3D printing.

13. The system of claim 8, wherein the nominal shape model includes a data file used to form the manufactured component.

14. The system of claim 8, wherein the manufactured component includes a turbomachine component.

15. A computer program product comprising program code, which when executed by at least one computing device, causes the at least one computing device to detect deformation in a manufactured component, by performing actions including:
obtaining a post-deployment three-dimensional (3D) depiction of the manufactured component after operational deployment;
obtaining a model of the manufactured component including: a nominal shape model indicating a nominal shape of the manufactured component prior to operational deployment, and an expected deformation model indicating expected deformation of the manufactured component after operational deployment;
aligning a localized region of the manufactured component in the post-deployment 3D depiction with the localized region of the manufactured component in the nominal shape model;
identifying a first set of points in the localized region not subject to deformation between the post-deployment 3D depiction and the nominal shape model; and
identifying a second set of points in the localized region subject to deformation between the post-deployment 3D depiction and the nominal shape model.

16. The computer program product of claim 15, wherein the program code further causes the at least one computing device to obtain a pre-deployment 3D depiction of the manufactured component prior to operational deployment.

17. The computer program product of claim 16, wherein the program code further causes the at least one computing device to compare the pre-deployment 3D depiction of the manufactured component with the nominal shape model to identify a manufacturing variation in the manufactured component.

18. The computer program product of claim 15, wherein the localized region is selected based upon a common manufacturing process used to manufacture a portion of the component.

19. The computer program product of claim 18, wherein the common manufacturing process includes at least one of casting, forging or 3D printing.

20. The computer program product of claim 15, wherein the nominal shape model includes a data file used to form the manufactured component.
